(19) United States
(12) Patent Application Publication
(10) Pub. No.: US 2024/0275501 A1
(43) Pub. Date: Aug. 15, 2024

(54) A RADIO NETWORK DISTRIBUTION BOARD

(71) Applicant: Telefonaktiebolaget LM Ericsson (publ), Stockholm (SE)

(72) Inventors: Christian Braun, VALLENTUNA (SE); Hao Zhang, GUANGZHOU (CN); Ling Zhang, Göteborg (SE)

(21) Appl. No.: 18/564,078

(22) PCT Filed: May 31, 2021
(86) PCT No.: PCT/CN2021/097377

§ 371 Date: Nov. 25, 2023

(51) Int. Cl. H04B 17/00

(52) U.S. Cl. CPC H04B 17/0085

(57) ABSTRACT

Embodiments described herein relate to a Radio Distribution Network Board, RDNB, for testing functionality of a plurality of radio chains, and to a method of calibrating a plurality of radio chains using said RDNB. The RDNB comprises a plurality of first ports for connecting to the plurality of radio chains; a plurality of second ports for connecting to one or more external devices, wherein each first port is coupled to a respective second port; and a plurality of coupling paths, wherein each coupling path is configured to provide coupling between two first ports, and wherein each coupling path comprises one or more non-directional power splitter/combiners.

### TECHNICAL FIELD

Embodiments described herein relate to the use of a Radio Distribution Network Board for performing a calibration procedure of a plurality of radio chains.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Currently radio products that employ antenna calibration are based on a coupler network-based calibration function. With this solution, it is straightforward to replace the antenna board with a so-called Radio Distribution Network Board (RDNB). An RDN (as described in 3GPP TS 37.105 v14.1.0) is a passive network which distributes the RF power generated by a transceiver unit array to, for example, an antenna array. In some examples, this passive network may be used to connect the radio chains to one or more external devices which may then test the calibration of the radio chains.

FIG. 1a illustrates an example of an RDNB 100. The RDNB 100 comprises first ports 101a to 101p configured to connect to the radio chains, and second ports 102a to 102p configured to connect to the one or more external devices. Not all of the first ports 101 and the second ports 102 are numbered for clarity.

The RDNB board therefore replaces antenna radiating elements with connectors, which enables cabled measurements and verification of various beamforming features.

FIG. 1b illustrates the same example RDNB 100 as FIG. 1a. In FIG. 1b some of the first ports 101 and second ports 102 have been omitted for clarity.

From FIG. 1b is can be seen that the RDNB 100 further comprises a calibration coupler network. The calibration coupler network comprises a sum/splitter 103 and a calibration port 104. A directional coupler may be used to couple the sum/splitter 103 to each first port 101, and the signal from each first port 101 may then be combined at the sum/splitter 103 to be feed into the calibration port 104.

This calibration coupler network is similar to those provided on antenna boards, and it allows for calibrated radio paths at the RDNB coupler interface.

However, Recent advances in antenna calibration field include development of a calibration procedure which accounts for mutual over the air (OTA) antenna coupling in an antenna array. This calibration procedure uses no dedicated coupler network but instead relies on antenna mutual coupling for the calibration function. Applying an RDNB board to a product utilizing this sort of calibration procedure provides no straightforward means to calibrate the radio chains, since there are no antenna radiating elements present.

One key attribute for future Fifth Generation (5G) radio systems is increased capacity in radio networks. Beamforming is one technology that will be used by 5G radio systems to provide the desired increased capacity in an efficient manner. In particular, a 5G radio base station will utilize a large antenna array including tens if not hundreds of antennas, which are also referred to herein as antenna elements. Each antenna element (or each sub-array of antenna elements) is connected to a radio transceiver path. Applying proper scaling in the transceiver paths enables beamforming by efficient control of spatial coherent additions of desired signals and coherent subtractions of unwanted signals. Such beamforming is used both to enable high antenna gain to a desired User Equipment (UE) as well as to enable parallel communication to several UEs using the same time/frequency resource by using orthogonal spatial communication paths (i.e., by using orthogonal beams).

One issue that arises when implementing a radio base station that utilizes beamforming is that there are variations in gain and phase between different antenna paths (i.e., between different radio transmitter paths and between different radio receiver paths). To enable precise beamforming, full control of vector additions of high frequency radio signals is needed. Hence, very accurate control of amplitude and phase may be required. This accuracy is needed in every transceiver path. In order to achieve this accuracy, a calibration procedure may be applied to compensate for amplitude and phase variations between different transceiver paths.

The calibration procedure may comprise a self-calibration of an active antenna system using mutual aperture couplings between antenna elements or between sub-arrays in the antenna array, simultaneous transmission orthogonal test signals, and measurements of resulting coupled path signals. By using orthogonal test signals, multiple measurements can be obtained simultaneously. In this manner, the self-calibration procedure can be performed in an efficient manner.

FIG. 1c illustrates an example embodiment of a radio system 100 that provides self-calibration for an antenna array. The radio system 100 is also referred to herein as a beamforming transceiver. The radio system 100 is preferably a radio access node in a cellular communications network (e.g., a base station in a 3GPP 5G NR network). However, the radio system 100 may alternatively be, for example, an access point in a local wireless network (e.g., an access point in a WiFi network), a wireless communication device (e.g., a UE in a 3GPP 5G NR network), or the like. The radio system 100 performs beamforming via an antenna array. This beamforming may be, e.g., analog beamforming, which is performed by controlling gain and phase for each antenna branch via respective gain and phase control elements. However, it should be appreciated that, in some other embodiments, the radio system 100 may perform, e.g., hybrid beamforming, i.e., perform beamforming partly in the digital domain and partly in the analog domain or may perform digital beamforming (i.e., beamforming fully in the digital domain), which may be time domain or frequency domain digital beamforming.

As illustrated, the radio system 100 includes a processing unit 102 and an active antenna system 104. In some examples, the active antenna system 104 is implemented as one or more radio ASICs, and the processing unit 102 is a baseband processing unit implemented as, e.g., one or more processors such as, e.g., one or more CPUs, one or more baseband ASICs, one or more Field Programmable Gate Arrays (FPGAs), one more Digital Signal Processors (DSPs) or the like, or any combination thereof.

The active antenna system 104 comprises an antenna array comprising a plurality of sub-arrays. Each sub-array comprises a one or more Antenna Elements (AEs). The active antenna system 104 may comprise radio chains for each sub-array. As an example, each radio chain may comprise a gain control element and a phase control element that are controlled by the processing unit 102 to provide gain and phase calibration between the radio chains and, in some embodiments, analogue beamforming weights for signals transmitted by the radio system 100. Note that analogue calibration and analogue beamforming are shown herein as an example; however, the present disclosure is not limited thereto.

The processing unit 102 includes a self-calibration subsystem 106. The self-calibration subsystem 106 includes a controller 108, a test signal generator and measurement function 110 including in this example encoders 112 and decoders 114, and a measurement processing function 116. The controller 108 generally operates to control the self-calibration subsystem 106 and the active antenna system 104 to perform a self-calibration procedure as described herein. The test signal generator and measurement function 110 includes the encoders 112 that generate orthogonal test signals, for example, in real-time and in the time domain using different orthogonal codes. The orthogonal test signals are provided to the active antenna system 104 for simultaneous transmission by respective transmit sub-arrays.

In response to the simultaneous transmission of the orthogonal test signals, the active antenna system 104 provides received signals that are received via at least some receive sub-arrays as a result of mutual couplings between the transmit and receive sub-arrays. Each of these received signals is a combination of signals received at the respective receive sub-array from the one or more transmit sub-arrays during simultaneous transmission of the orthogonal test signals due to mutual coupling. As such, these received signals are also referred to herein as “combined” signals. For each of these combined signals, the decoders 114 include decoders that simultaneously decode the combined signal, preferably in the time domain, to provide separate receive signals received via the respective receive sub-array from a limited subset of the transmit sub-arrays. After decoding, the resulting decoded signals are stored as measurements. Multiple measurement steps are performed until all desired measurements are obtained.

Once all of the desired measurements are obtained, the measurement processing function 116 processes the measurements to determine gain and phase calibration values for the radio chains of the active antenna system 104. The controller 108 then controls the gain and phase control elements in the transmit and receive branches of the active antenna system 104 in accordance with the determined gain and phase calibration values.

Radio products employing the calibration procedure described above based on mutual aperture coupling as described above (MCAC) have building practice, modularity and cost advantages compared to traditional AC solution based on couplers.

The calibration procedure as described above is based on a measured calibration signal path from one radio chain that is configured in transmission mode, to neighbouring radio chains that are configured in receiving mode. The signal path goes via the antenna mutual aperture coupling that is present in any antenna array.

The calibration procedure as described above therefore depends on the mutual aperture coupling occurring between the antenna elements having a magnitude within a certain range. The calibration procedure may, in particular, exploit antenna properties that the mutual aperture coupling is stronger for the closest neighbouring elements in the array geometry. However, for some antenna design choices, the mutual aperture coupling between antenna elements may be very low even for closely spaced elements. This causes less signal to be coupled through the mutual aperture coupling, deteriorating the SINR of the measured mutual aperture coupling signal. Poor SINR in its turn degrades the calibration accuracy of the solution. Interference may originate from co-located equipment, user equipments (UEs) or any other interference source.

The beamforming performance of products utilizing the calibration procedure as described with reference to FIG. 1c can be tested and verified in Over-The Air (OTA) measurement chambers. However, OTA test chambers are expensive and space consuming, and may not be possible to utilize for all needed verifications.

Existing conductive tests measure the beamforming performance via test equipment with low cost. Such tests require antenna branches to be calibrated in a conductive environment. However, as discussed existing RDNBs cannot support these requirements for products utilizing calibration procedures based on mutual antenna coupling.

### SUMMARY

According to some embodiments there is provided a Radio Distribution Network Board, RDNB, for testing functionality of a plurality of radio chains. The RDNB comprises a plurality of first ports for connecting to the plurality of radio chains; a plurality of second ports for connecting to one or more external devices, wherein each first port is coupled to a respective second port; and a plurality of coupling paths, wherein each coupling path is configured to provide coupling between two first ports, and wherein each coupling path comprises one or more non-directional power splitter/combiners.

According to some embodiments there is provided a method of calibrating a plurality of radio chains, wherein the plurality of radio chains are connected to a plurality of first ports on a Radio Distribution Network Board, wherein the RDNB comprises: a plurality of coupling paths, wherein each coupling path is configured to provide coupling between two first ports, and each coupling path comprises one or more non-directional power splitter/combiners; and a plurality of second ports for connecting to one or more external devices, wherein each first port is coupled to a respective second port. The method comprises transmitting a first signal over each transmitting branch of the plurality of radio chains; receiving second signals at each receiving branch of the plurality of radio chains caused by the plurality of coupling paths; and calibrating phase settings and/or amplitude settings of the plurality of radio chains based on the received second signals.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1a illustrates an example of an RDNB 100;

FIG. 1b illustrates the same example RDNB 100 as FIG. 1a;

FIG. 1c illustrates an example embodiment of a radio system 100 that provides self-calibration for an antenna array;

FIG. 2 illustrates a Radio Distribution Network Board, RDNB 200 according to some embodiments;

FIG. 3 illustrates an example of a portion of an antenna array 300 that the radio chains would otherwise be connected to;

FIG. 4 illustrates a part of a proposed layout for a RDNB 400 according to some embodiments;

FIG. 5 illustrates example mutual coupling levels achieved with the RDNB 400;

FIG. 6 illustrates a part of a proposed layout for a RDNB 600 according to some embodiments;

FIG. 7 illustrates an alternative example of a part of a RDNB 700 for implementing the cross-coupling coupling paths;

FIG. 8 illustrates example mutual coupling levels achieved with the RDNB 600;

FIG. 9 illustrates a system for use in performing the calibration procedure as described with reference to FIG. 1c, whilst utilising an RDNB 900 board as described with reference to any of FIGS. 2 to 8;

FIG. 10 illustrates a method of calibrating a radio chains of an active antenna system according to some embodiments;

FIG. 11 illustrates the signals transmitted during the method of calibrating of FIG. 10;

FIG. 12 illustrates an apparatus comprising processing circuitry (or logic) according to some embodiments.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein relate to a Radio Distribution Network Board and to a method of calibration. The RDNB presents the same connector interface as existing RDNBs but further comprises a coupler network that emulates antenna mutual coupling. The coupler network may be implemented in the RDNB circuit board (PCB) and does therefore not radiate signal into the air.

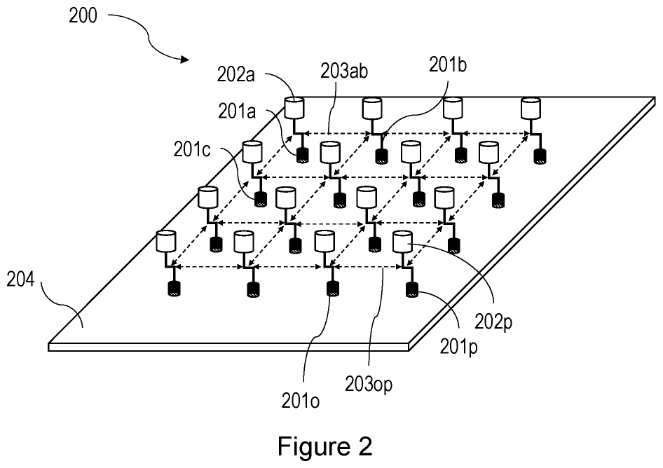

FIG. 2 illustrates a Radio Distribution Network Board, RDNB 200 according to some embodiments. Similarly to previous RDNBs, the RDNB 200 comprises a linear passive network which distributes the RF power generated by an array of radio chains array to one or more external devices, and/or distributes radio signals collected by external devices to the radio chains array, in an implementation specific way.

The RDNB 200 may, for example, be used to test functionality of a plurality of radio chains. The radio chains may comprise receiver chains, transmitter chains or transceiver chains.

The RDNB 200 comprises a plurality of first ports 201a to 201p (not all first ports are numbered for clarity) for connecting to the plurality of radio chains. The plurality of first ports 201a to 201p may be arranged in, for example, a two dimensional array. It will be appreciated that the terms “connected” and “connecting” as used herein are not intended to be limited to directly connected or connecting. In other words, there may be other elements connected between two elements which are described as being connected together.

The RDNB 200 further comprises a plurality of second ports 202a to 202p (not all second ports are numbered for clarity) suitable for connecting to one or more external devices, wherein each first port 201a to 201p is connected to a respective second port 202a to 202p. In this example, the first ports 201a to 201p and the second ports 202a to 202p are positioned on opposite sides of a PCB 204. It will however be appreciated that in some designs, the first ports 201a to 201p and second ports 202a to 202p may be positioned on the same side of a PCB.

The RDNB further comprises a plurality of coupling paths 203ab to 203op (not all coupling paths are numbered for clarity), wherein each coupling path is configured to provide coupling between two first ports. For example, the coupling path 203a provides coupling between the first port 201a and the first port 201b.

The coupling paths 203ab to 203op provide coupling between each pair of first ports that is of a magnitude representative of mutual antenna coupling.

The coupling paths 203ab to 203op may provide some level of coupling between all of the first ports 201a to 201p.

For example, the arrangement of the array of first ports may match an arrangement of antenna elements in an antenna array that the radio chains would otherwise be connected to.

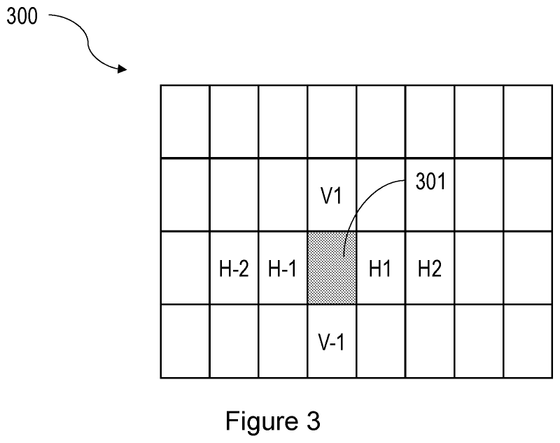

FIG. 3 illustrates an example of a portion of an antenna array 300 that the radio chains would otherwise be connected to.

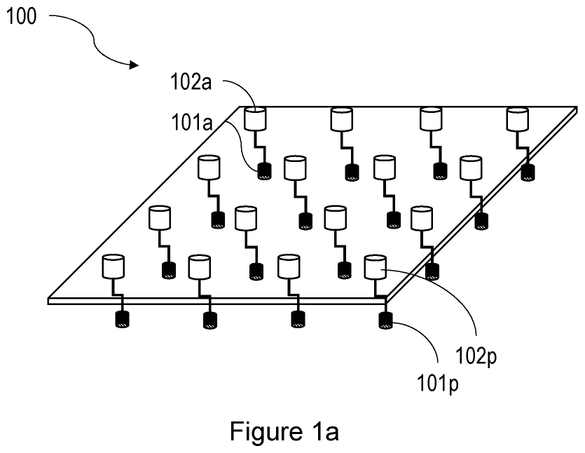

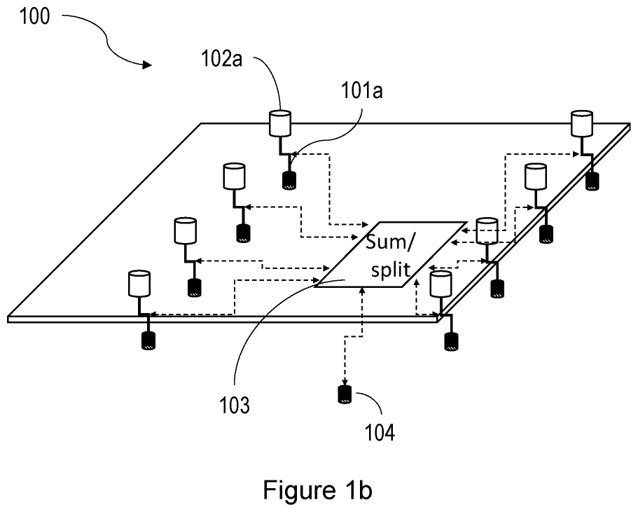

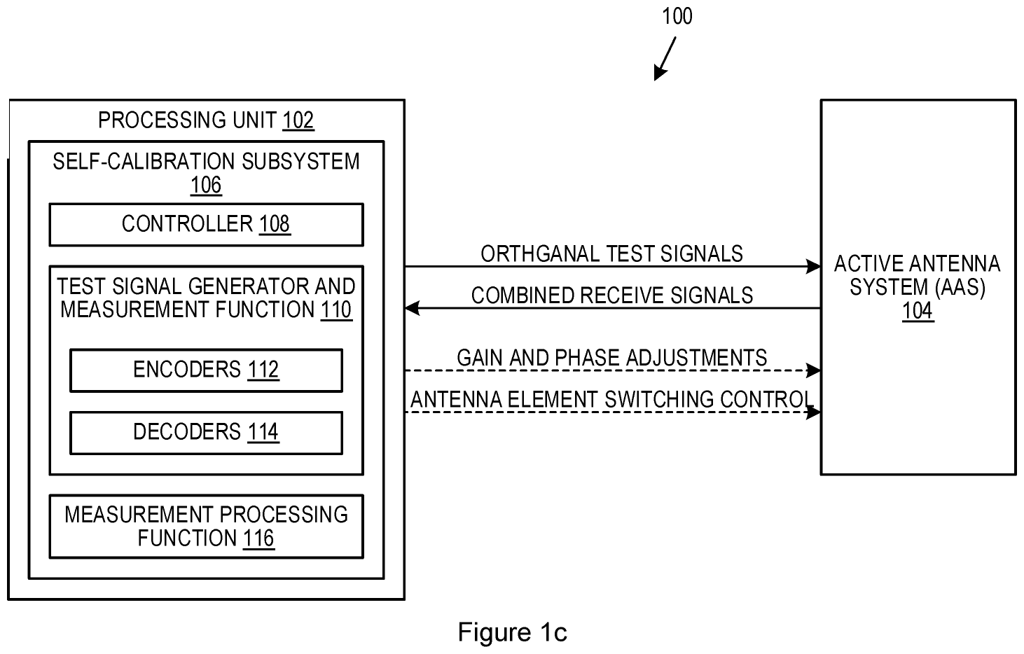

The antenna mutual coupling happens over the air and is normally strongest between the most closely spaced antenna elements. This is exploited in the calibration procedure as described with reference to FIG. 1.

For example, for the antenna element 301, H1/-1 denotes the closest horizontal neighbour in the antenna array; H2/H-2 denotes the second closest horizontal neighbour in the antenna array; and V1/-1 denotes the closest vertical neighbour in the antenna array. In some examples the spacing between vertical closest neighbours in the antenna array is greater than the spacing between horizontal closest neighbours in the antenna array.

The mutual antenna coupling levels vary with antenna designs (and antenna array designs) but typical levels are around −20 to −25 dB for H1 and H-1, −30 to −35 dB for H2 and H-2, −30 to −35 dB for V1 and V-1.

For example, the first port 201a may be configured to represent the antenna element 301. In this example, the coupling between, for example, first ports 201a And 201c may be representative of the mutual antenna coupling that would occur between two antenna elements positioned vertically adjacent to one another in an antenna array (for example in the range −30 to −35 dB). Similarly, the coupling between the first port 201a and the first port 201b may be representative of the mutual antenna coupling that would occur between two antenna elements positioned horizontally adjacent to one another in an antenna array (e.g. −20 to −25 dB). The same logic may then be applied to each pair of first ports in the array of first ports (201a to 201p).

Generally, the coupling paths 203ab to 203op may be configured to provide stronger coupling between pairs of first ports that represent antennas that are geometrically closer. It will also be appreciated that the coupling provided by the coupling paths may be equal between pairs of first ports that would otherwise be connected to antenna elements having the same relative positions. For example, the magnitude of the coupling between first port 201a and first port 201b may be the same as the magnitude of the coupling between first port 201p and first port 201o.

In some examples, the magnitude of the coupling provided between two first ports may be X, wherein −50 dB≤X≤−15 dB. This may be considered a typical magnitude for mutual antenna coupling, although it will be appreciated that in some circumstances mutual antenna coupling (for example for antenna elements that are geometrically spaced apart) may fall outside of this range.

Each coupling path comprises one or more non-directional power splitter/combiners. The non-direction power splitter/combiners may have any suitable number of ports (e.g. multiple ports). In some example, at least one of the non-directional power splitter/combiners comprises either a 3-port non-directional power splitter/combiner or a 4-port non-directional power splitter/combiner. In some examples, one or more of the plurality of coupling paths further comprises an attenuator.

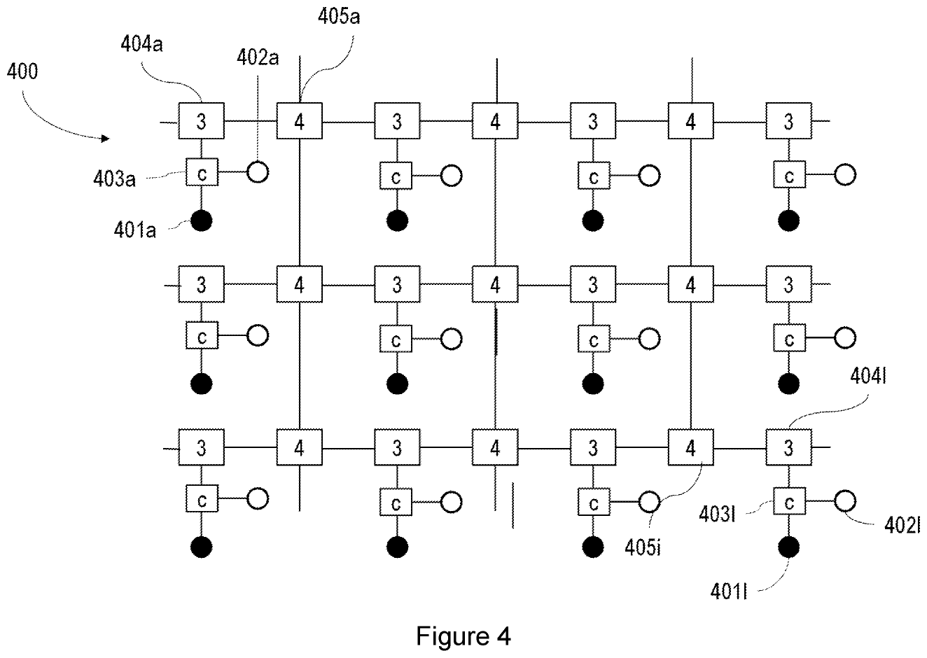

FIG. 4 illustrates a part of a proposed layout for a RDNB 400 according to some embodiments. This RDNB 400 is configured to connect to radio chains that would otherwise be connected to an array of antenna elements operating in a first polarisation.

The solid circles 401a to 4011 (not all solid circles are numbered for clarity) represent the first ports for connecting to the radio chains. The clear circles 402a to 4021 (not all clear circles are numbered for clarity) represent the second ports for connecting to one or more external devices.

In this example, each first port 401 is connected to a respective second port 402 by a directive coupler 403 (not all directive couplers are numbered for clarity, but the directive couplers are represented by “c”) that couples at least part of the signal from the first port to the second port. Each directive coupler 403 may have a coupling factor of around 20 dB. In some examples, each first port 401 may be coupled to a respective second port 402 instead by a power splitter.

For example, a Wilkinson split may be used instead of the directive coupler. A Wilkinson split is an ideally lossless power splitter. Isolation between the output ports is high.

It will be appreciated that any suitable component that couples a significant portion of the signal from the first port to the second port may be used.

In this example, the RDNB 400 further comprises 3-port non-directional power splitter/combiners 404a to 4041 (not all are numbered for clarity, but the 3-port non-direction power splitter/combiners are represented by “3”), and 4-port non-directional power splitter/combiners 405a to 405i (not all are numbered for clarity, but the 4-port non-direction power splitter/combiners are represented by “4”). It will be appreciated that in some cases not all ports of the non-directional power splitter/combiners are illustrated. The non-directional power splitter/combiners may comprise resistive power splitter/combiners.

Each coupling path, in this example RDNB 400, comprises at least one non-directional power splitter (e.g. a power splitter/combiner that has the same transfer function in any direction). In this example, each coupling path comprises at least two 3-port non-directional power splitter/combiners 404. Each 3-port non-directional power splitter/combiner has typically approximately a 6 dB insertion loss from one port to another.

In this example each coupling path further comprises at least one 4-port non-directional power splitter/combiner 405. Each 4-port non-directional power splitter/combiner 405 has typically approximately a 10 dB insertion loss from one port to another.

The layout of the RDNB 400, with the coupler components and the power splitter/combiner components, creates a mutual coupling matrix or grid that provides coupling between all first ports 401. The coupling between all first ports 401 may be provided by the non-directional properties of the power splitter/combiners 404, 405. The resulting coupling is stronger for closely spaced first ports and weaker for more distant first ports. This variation in the coupling strength is because more distant first ports have several power splitter/combiners (404, 405) between them, thus providing more loss in the signal path. These properties mimic the properties of OTA mutual coupling of a real antenna array matrix.

It will be appreciated that any suitable components may be inserted into the coupling paths that would introduce insertion losses in the signal paths between first ports. For example, attenuators may be used. The insertion loss of an attenuator may be tuneable, which may be advantageous in tuning the design of the RDNB such that the desired coupling magnitudes can be reached.

It will be appreciated that the RDNB 400 may be implemented in a single PCB layer where the only vias needed would be to the first ports and the second ports. Moreover, the design of the RDNB is modular, and may therefore be extended to an arbitrary array size in terms of rows and columns.

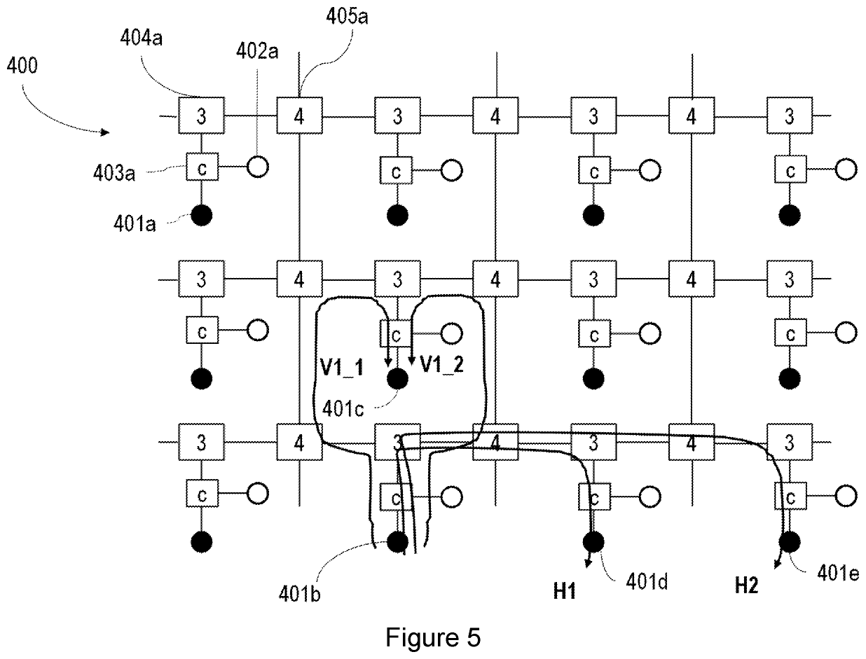

FIG. 5 illustrates example mutual coupling levels achieved with the RDNB 400, for paths between a first port 401b and the first ports 401c (signal paths V1_1 and V1_2)401d (signal path H1) and 401e (signal path H2). The insertion losses caused by the directive couplers and the transmission lines are small and are therefore not considered in the evaluation.

In this example, each 3-port non-directional power splitter/combiner 404 is assumed to provide an insertion loss of −6 dB. In this example, each 4-port non-directional power splitter/combiner 405 is assumed to provide an insertion loss of −10 dB.

For the signal path H1, the 3-port and 4-port non-directional power splitter/combiners 404 and 405 introduce total insertion losses of −22 dB (e.g. two 3-port non-directional power splitter/combiners and one 4-port non-directional power splitter/combiner).

For the signal path H2, the 3-port and 4-port non-directional power splitter/combiners 404 and 405 introduce total insertion losses of −38 dB (e.g. three 3-port non-directional power splitter/combiners and two 4-port non-directional power splitter/combiners).

The H2 signal path therefore provides weaker coupling between the first port 401b and the first port 401e than the H1 signal path provides between the first port 401b and the first port 401d.

The magnitude of the coupling between the first port 401b and the first port 401c is created by two equal strength paths (V1_1 and V1_2) that are added coherently. The magnitude of the coupling provided by V1_1 and V1_2 individually is −32 dB (e.g. two 3-port non-directional power splitter/combiners and two 4-port non-directional power splitter/combiners). When this is added coherently, the resulting total insertion loss is −26 dB.

The coupling level provided by the combination of V1_1 and V1_2 may be somewhat higher than would be provided naturally in an antenna array, but this may easily be tuned by adding attenuators, for example, between the adjacent 4-port non-directional splitter/combiners.

It will be appreciated that coupling levels similar to the typical antenna mutual coupling levels are therefore achieved.

The coupling paths therefore provide enough mutual coupling for the radio function to perform the calibration procedure and to calibrate the radio with a reference plane at the first ports 401. The directive couplers 403 then couple the signal to the second ports 402. The signal paths between the directive couplers and the second ports may be equal for every branch, so that the calibration achieved at the first ports 401 is maintained.

Each of the coupling paths illustrated in FIG. 4 provide coupling between two first ports 401, wherein the two first ports 401 are both configured to couple to radio chains that would otherwise be coupled to one or more antenna elements operating in a first polarisation. However, real antenna OTA mutual coupling also contains coupling between polarisations, a fact that is utilized in the calibration procedure described with reference to FIG. 1.

Two RDNBs 400 according to FIG. 4 may be used with two parallel networks, one per polarisation. This set up could provide sufficient coupling to calibrate each polarisation individually. However, the cross coupling between the polarisations would not be calibrated. This may be sufficient for most cases since most beamforming features do not require calibration between polarisations. However, adding coupled paths between polarisations would provide the calibration procedure with more information, and therefore improve the calibration quality.

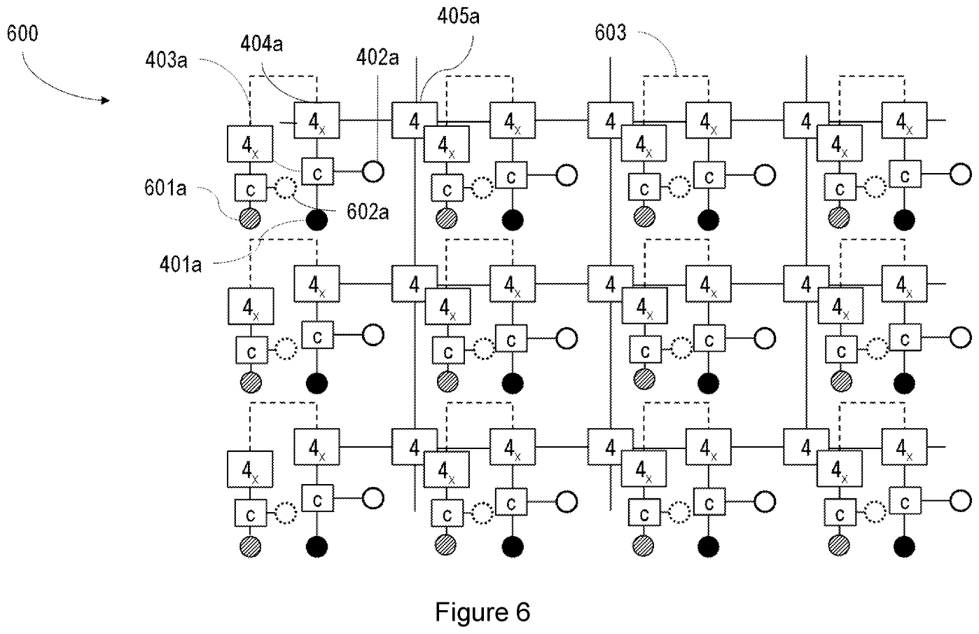

FIG. 6 illustrates a part of a proposed layout for a RDNB 600 according to some embodiments. This RDNB 600 is configured to couple to radio chains that would otherwise be coupled to an array of antenna elements where some antenna elements are operating in a first polarisation and other antenna elements are operating in a second polarisation different to the first polarisation.

In FIG. 6, the entire RDNB 400 is included (reference numbers are also the same as described with reference to FIG. 4). This RDNB 400 may then couple radio chains that would otherwise be coupled to antenna elements operating in a first polarisation.

A second matrix of first ports 601a to 6011 (represented by stripped circles in FIG. 6, where not all are numbered for clarity), and second ports 602a to 6021 (represented by dashed circles in FIG. 6, where not all are numbered for clarity) is then also provided in the RDNB 600. This matrix may be laid out in exactly the same was as RDNB 400 (e.g. with the first ports 601 coupled to respective second ports 602, and with coupling paths with, for example, 3-port and 4-port non-directional power splitter/combiners provided between the first ports 601), however, the entire matrix of coupling paths is not shown for clarity. It will be appreciated that in some cases not all ports of the non-directional power splitter/combiners are illustrated.

RDNB 600 further comprises at least one coupling path 603 configured to provide coupling between a first port 401 configured to couple to a radio chain that would other wire be coupled to one or more antenna elements operating in a first polarisation, and a first port 601 configured to couple to a radio chain that would otherwise be coupled to one or more antenna elements operating in a second polarisation. In other words, the RDNB 600 provides at least one coupling path 603 configured to mimic the cross coupling between polarisations in an antenna array.

In this example, each first port 601 is coupled to a respective first port 401 by a coupling path.

In the example illustrated in FIG. 6, the cross-coupling coupling paths 603 are provided by turning the 3-port non-directional power splitter/combiners 404 into 4-port non-directional power splitter/combiners (indicated as “4ₓ” which are similar to “4”) where the 4^{th} port provides the connection between polarisations. It will be appreciated that this implementation may create the need for multiple layer implementation in PCB due to lines crossing on multiple occasions.

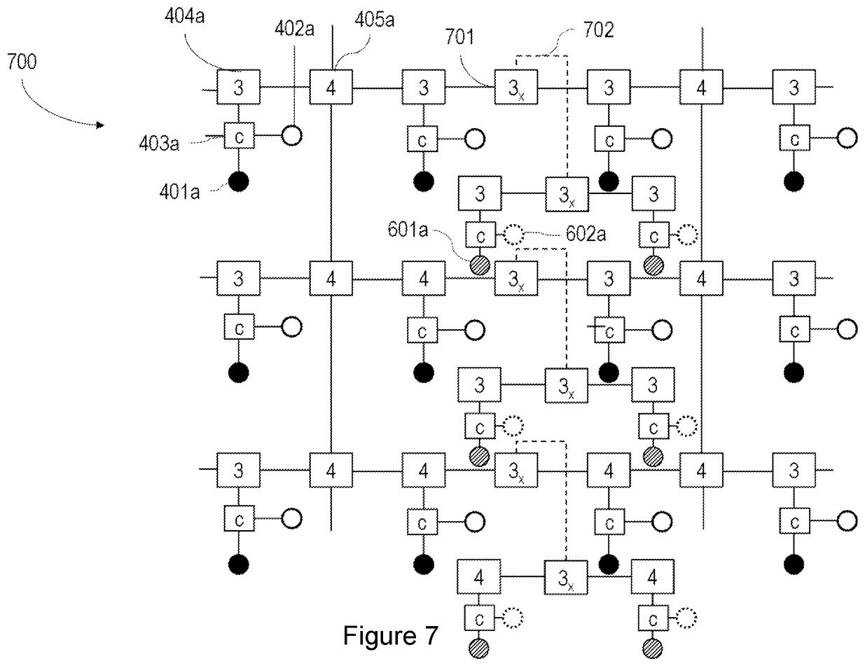

FIG. 7 illustrates an alternative example of a part of a RDNB 700 for implementing the cross-coupling coupling paths.

Similarly to as in FIG. 6, only part of the matrix for the second polarisation is illustrated for simplicity.

In this example, every second 4-port non-directional power splitter/combiner 405 splits (in both polarisation networks) are replaced by a 3-port non-directional power splitter/combiner 701 (referred to as “3ₓ”). The cross-coupling coupling path 702 therefore provides a signal path via the 3-port non-direction power splitter/combiners 701 “3ₓ”. Here ‘3ₓ’ is a 3-port non-directional power splitter/combiner similar to ‘3’.

When comparing the solution provided in FIG. 6 to the solution provided in FIG. 7, the solution in FIG. 7 has lower cross-coupling vertical coupling magnitudes but stronger cross-coupling horizontal coupling magnitudes. The implementation of FIG. 7 also provides fewer physical paths between the first polarisation matrix and the second polarisation matrix.

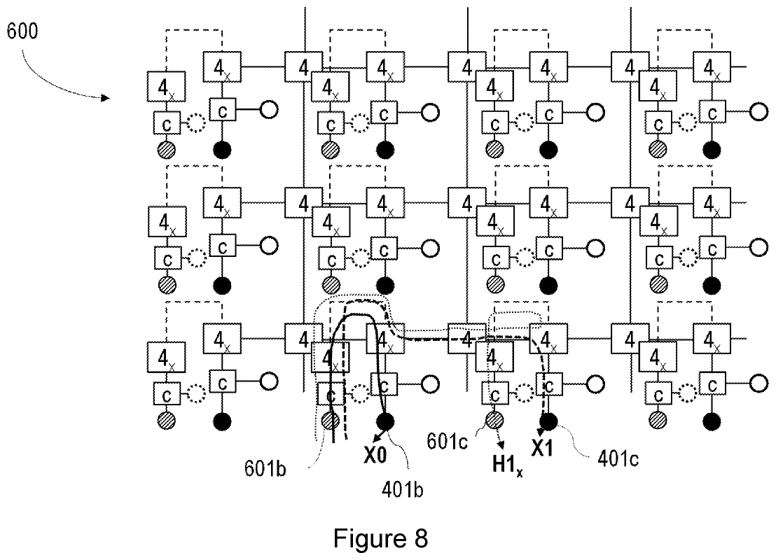

FIG. 8 illustrates example mutual coupling levels achieved with the RDNB 600, for the cross-coupling signal paths between a first port 601b and the first ports 401b (signal path X0) 401c(signal path X1) and 601c (signal path H1ₓ). The insertion losses caused by the directive couplers and the transmission lines are small and are therefore not considered in the evaluation.

In this example, each 4-port non-directional power splitter/combiner “4ₓ” is assumed to provide an insertion loss of −10 dB. It will be appreciated that the 3-port and 4-port non-directional power splitter/combiners may be configured with different insertion losses depending on their design. In this example, each 4-port non-directional power splitter/combiner “4” is assumed to provide an insertion loss of −10 dB.

For the signal path X0, the 4-port non-directional power splitter/combiners “4” and “4ₓ” introduce total insertion losses of −20 dB (e.g. two 4-port non-directional power splitter/combiners “4ₓ”).

For the signal path X1, the 4-port non-directional power splitter/combiners 4” and “4ₓ” introduce total insertion losses of −40 dB (e.g. three 4-port non-directional power splitter/combiners “4ₓ” and one 4-port non-directional power splitter/combiners “4”).

For the signal path H1ₓ, the 4-port non-directional power splitter/combiners 4” and “4ₓ” introduce total insertion losses of −50 dB (e.g. four 4-port non-directional power splitter/combiners “4ₓ” and one 4-port non-directional power splitter/combiners “4”). It will be appreciated that a co-coupling path between the first ports 601b and 601c (e.g. similar to H1 described above with reference to FIG. 5) is also provided, but not illustrated.

This co-coupling path will have a much lower insertion loss, and therefore the H1ₓ cross-coupling path brings very little multipath effect to the system in this case.

It will be appreciated that FIGS. 2 to 8 illustrate example implementations of embodiments of an RDNB described herein, and other arrangements of components may be used.

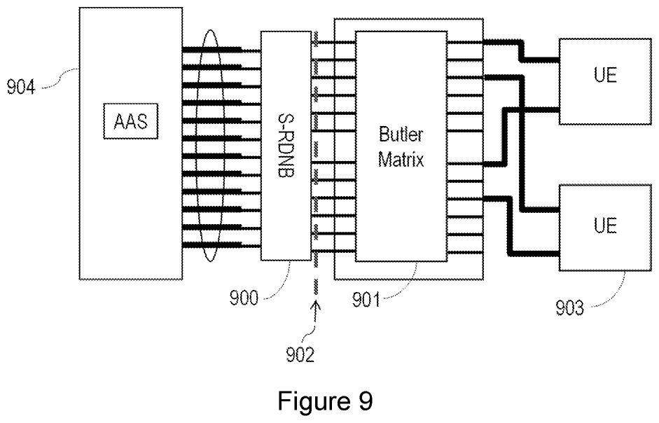

To create a calibrated system there may be requirements on the RDNB board, for example either:
1. Equal coupling—in which the coupling paths are carefully designed and manufactured so that they create exactly equal coupling in amplitude and phase between same relatively positioned ports. For example, the coupling between a first port and its relative H1 ports must be the same for all relative positions on the RDNB.
2. Characterized coupling—in which the coupling paths are not equal but are characterized in a calibration step. The coupling characteristics are stored in a database format and used by the radios calibration procedure to provide the calibration plane (as indicated in FIG. 9). The characterising may comprise determining amplitude coupling values and phase coupling values associated with each coupling path. The characterising may be performed by transmitting a signal to all of the radio chains coupled to the RDNB via the second ports.

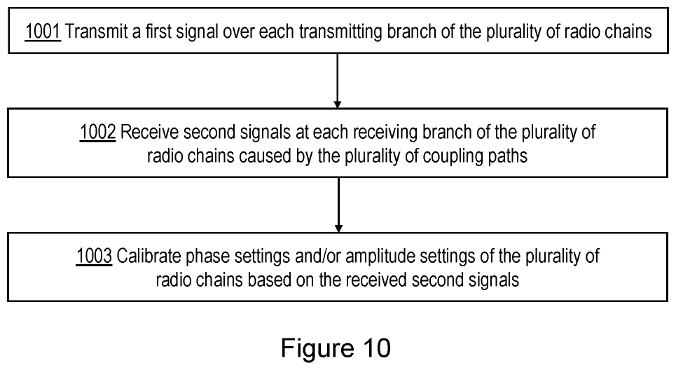

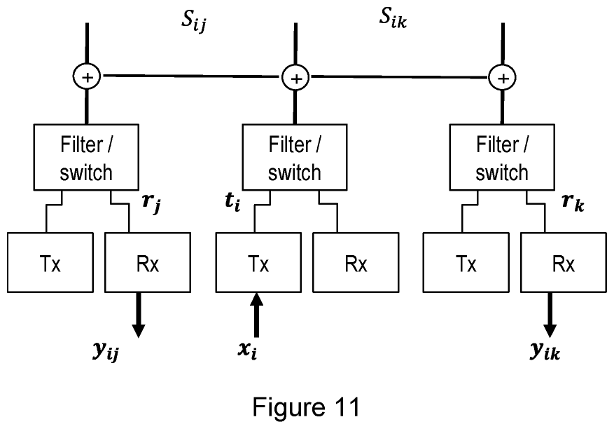

FIG. 9 illustrates a system for use in performing the calibration procedure as described with reference to FIG. 1c, whilst utilising an RDNB 900 board as described with reference to any of FIGS. 2 to 8. The system comprises an active antenna system comprising a plurality of radio chains. These radio chains are coupled to the first ports in the RDNB 900. The second ports in the RDNB 900 are coupled to an antenna beam box 901 (or a Butler matrix). The antenna beam box 901 all signals received from the second ports together to form a single output. The single output may have zero phase shift to mimic beamforming into boresight. The active antenna system (AAS) 904 may then perform a calibration procedure (for example as described with reference to FIGS. 10 and 11 below) aligns all the signals to the calibration plane 902. Hence some beamforming or Cell shaping test may be performed on the antenna beam box and UEs 903.

FIG. 10 illustrates a method of calibrating a radio chains of an active antenna system, wherein the plurality of radio chains are connected to a plurality of first ports on a Radio Distribution Network Board, wherein the RDNB comprises a plurality of coupling paths, wherein each coupling path is configured to provide coupling between two first ports. The method may be performed by an apparatus such as, for example, an active antenna system, e.g. AAS 904 illustrated in FIG. 9.

The method of FIG. 10 will be described with reference to FIG. 11. FIG. 11 illustrates the signals transmitted during the method of calibrating of FIG. 10. FIG. 11 depicts the receiving (Rx) and transmitting (Tx) parts of each radio chain, and how they couple to the RDNB. The coupling paths provided by the RDNB are represented by the parameters of a matrix S.

In step 1001, the method comprises transmitting a first signal, xᵢ, over each transmitting branch of the plurality of radio chains. The first signal, xᵢ would then be transmitted through the coupling paths in the RDNB.

In step 1002, the method comprises receiving second signals (e.g. yᵢⱼ, yᵢₖ) at each receiving branch of the plurality of radio chains caused by the plurality of coupling paths.

In other words, the signal xᵢ is propagated through the coupling paths in the RDNB and received at the neighbouring Rx radio chains. The number of received second signals depends on the actual design of RDNB e.g. the coupling level and circuit connections, in combination with a cut-off signal level threshold below which the signal is not considered in the algorithm.

In step 1003, the method comprises calibrating phase settings and/or amplitude settings of the plurality of radio chains based on the received second signals.

For example, the second signals may be written as: yᵢⱼ=rⱼSᵢⱼtᵢxᵢ, where rⱼ is the transfer function of the Rx radio chain j, tᵢ is the transfer function of the Tx radio chain, i, and xᵢ is the signal transmitted by the Tx radio chain, i. Sᵢⱼ is then the effect of the coupling path between the first ports of the RDNB connected to the radio chain j and the radio chain i. As described above, Sᵢⱼ may be determined by equaling coupling or by a calibration step. For example, determining Sᵢⱼ may comprise determining amplitude coupling values and phase coupling values associated with each coupling path. This characterising of the coupling paths may be performed by transmitting a signal to all of the radio chains coupled to the RDNB via the second ports

The transfer function, bᵢⱼ, between the radio chains i and j may be written as: bᵢⱼ=yᵢⱼ/xᵢ=rⱼSᵢⱼtᵢ.

After injections of multiple first signals into multiple transmitting radio chains, the matrix of B of the transfer functions between various radio chains can be constructed as below, where N is the noise, R is the vector of the transfer functions of the Rx radio chains, T is the vector of the transfer functions of the Tx radio chains: B=RST+N.

The dimension of B may be much larger than the number of Tx and Rx radio chains, so the model may be considered an overdetermined set of equations. This may be seen as a standard (classical) parameter estimation problem; well-known standard algorithms such as Least-Squares, Maximum Likelihood etc., and performance analysis tools such as Cramer-Rao Bounds, can be applied directly. It will therefore be appreciated that there are therefore many methods that can be used to solve the R and T.

Herein one possible method for solving the overdetermined set of equations is illustrated.

In this example, the method further comprises obtaining a first estimate R′ of the matrix R. In other words, the method may comprise obtaining first estimates of first transfer functions associated with each of the plurality of radio chains receiving branches (Rx).

The method may then further comprise estimating T from b=B(T′; R′)+n assuming R′ is fixed. In other words, the method may further comprise estimating, based on the first estimates (R′) and the coupling values (Sᵢⱼ), second estimates T′ of second transfer functions associated with each of the plurality of radio chains transmitting branches

The method may then further comprise estimating R′ from b=B(R′; T′)+n assuming T′ is fixed. In other words, the method may further comprise estimating the first transfer functions (R′) based on the second estimates (T′) and the coupling values (Sᵢⱼ) to update the first estimates (R′).

The method may then iteratively update the first estimates and the second estimated until the first estimates and the second estimates converge.

After R and T are solved, the compensations may be performed accordingly to align all the signals to the calibration plane as shown in FIG. 9. For example, the method may comprise adjusting the amplitude settings and/or phase settings of the plurality of radio chains to compensate for differences in the first transfer functions and differences in the second transfer functions.

It will be appreciated that the method of solving the calibration described here is just for example. There might be other suitable methods performed in the RDNB board and corresponding setup.

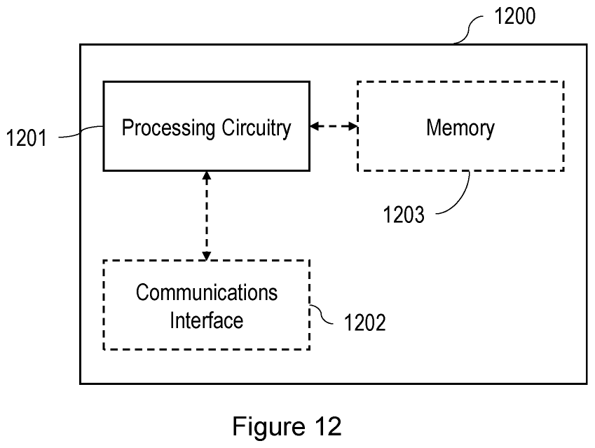

FIG. 12 illustrates an apparatus 1200 comprising processing circuitry (or logic) 1201. The processing circuitry 1201 controls the operation of the apparatus 1200 and can implement the method described herein in relation to an apparatus 1200. The processing circuitry 1201 can comprise one or more processors, processing units, multi-core processors or modules that are configured or programmed to control the apparatus 1200 in the manner described herein. In particular implementations, the processing circuitry 1201 can comprise a plurality of software and/or hardware modules that are each configured to perform, or are for performing, individual or multiple steps of the method described herein in relation to the apparatus 1200.

Briefly, the processing circuitry 1201 of the apparatus 1200 is configured to: transmit a first signal over each transmitting branch of the plurality of radio chains; receive second signals at each receiving branch of the plurality of radio chains caused by the plurality of coupling paths; and calibrate phase settings and/or amplitude settings of the plurality of radio chains based on the received second signals.

In some embodiments, the apparatus 1200 may optionally comprise a communications interface 1202. The communications interface 1202 of the apparatus 1200 can be for use in communicating with other nodes, such as other virtual nodes. For example, the communications interface 1202 of the apparatus 1200 can be configured to transmit to and/or receive from other nodes requests, resources, information, data, signals, or similar. The processing circuitry 1201 of apparatus 1200 may be configured to control the communications interface 1202 of the apparatus 1200 to transmit to and/or receive from other nodes requests, resources, information, data, signals, or similar.

Optionally, the apparatus 1200 may comprise a memory 1203. In some embodiments, the memory 1203 of the apparatus 1200 can be configured to store program code that can be executed by the processing circuitry 1201 of the apparatus 1200 to perform the method described herein in relation to the apparatus 1200. Alternatively or in addition, the memory 1203 of the apparatus 1200, can be configured to store any requests, resources, information, data, signals, or similar that are described herein. The processing circuitry 1201 of the apparatus 1200 may be configured to control the memory 1203 of the apparatus 1200 to store any requests, resources, information, data, signals, or similar that are described herein.

There is also provided a computer program comprising instructions which, when executed by processing circuitry (such as the processing circuitry 1201 of the apparatus 1200 described earlier, cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein provide ways to test the calibration procedure described with reference to FIG. 1 without using an actual antenna or antenna array. This is very useful in integration and verification since: existing test equipment and test environment can be used as is used in today's AAS integration and verification; and no special OTA measurement capability and shielded environment is needed to verify beamforming performance in node level verification.

RDNBs according to embodiments described herein may also be used to perform any conductive tests, other than the internal testing. With this solution the cost for product performance measurement or verification would be reduced significantly.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1: A Radio Distribution Network Board (RDNB) for testing functionality of a plurality of radio chains, the RDNB comprising:
a plurality of first ports for connecting to the plurality of radio chains;
a plurality of second ports for connecting to one or more external devices, wherein each first port is coupled to a respective second port; and
a plurality of coupling paths, wherein each coupling path is configured to provide coupling between two first ports, and wherein each coupling path comprises one or more non-directional power splitter/combiners.

2: The RDNB of claim 1, wherein one or more of the plurality of coupling paths further comprises an attenuator.

3: The RDNB as claimed in claim 1, wherein each coupling path comprises a plurality of non-directional power splitter/combiners and wherein each non-directional power splitter/combiner is a multi-port non-directional power splitter/combiner.

4: The RDNB as claimed in claim 3, wherein one of the multi-port non-directional power splitter/combiners comprises either a 3-port non-directional power splitter/combiner or a 4-port non-directional power splitter/combiner.

5: The RDNB as claimed in claim 1, wherein the coupling between the two first ports has a magnitude x, wherein −50 dB≤x≤−15 dB.

6: The RDNB as claimed in claim 1, wherein the plurality of coupling paths comprises a first coupling path configured to provide coupling between two first ports, wherein the two first ports are both configured to couple to radio chains that would otherwise be coupled to one or more antenna elements operating in a first polarisation.

7: The RDNB as claimed in claim 1, wherein the plurality of coupling paths comprises a second coupling path configured to provide coupling between two first ports, wherein one of the two first ports is configured to couple to a radio chain that would otherwise be coupled to one or more antenna elements operating in a first polarisation, and the other of the two first ports is configured to couple to a radio chain that would otherwise be coupled to one or more antenna elements operating in a second polarisation.

8: The RDNB as claimed in claim 1, wherein the plurality of coupling paths together provide some level of coupling between all of the plurality of first ports.

9: The RDNB as claimed in claim 1, wherein pairs of first ports that represent antenna elements that are geometrically closer have stronger coupling than pairs of first ports that represent antenna elements that are geometrically further apart.

10: The RDNB as claimed in claim 1, wherein each first port is connected to a respective second port by one or more of:
a directive coupler that couples at least part of the signal from the first port to the second port; and
a power splitter.

11: The RDNB as claimed in claim 1, wherein the coupling is equal between pairs of first ports representing antennas having the same relative positions.

12: A method of calibrating a plurality of radio chains, wherein the plurality of radio chains are connected to a plurality of first ports on a Radio Distribution Network Board (RDNB), wherein the RDNB comprises: a plurality of coupling paths, wherein each coupling path is configured to provide coupling between two first ports, and each coupling path comprises one or more non-directional power splitter/combiners; and a plurality of second ports for connecting to one or more external devices, wherein each first port is coupled to a respective second port, the method comprising:
transmitting a first signal over each transmitting branch of the plurality of radio chains;
receiving second signals at each receiving branch of the plurality of radio chains caused by the plurality of coupling paths; and
calibrating phase settings and/or amplitude settings of the plurality of radio chains based on the received second signals.

13: The method as claimed in claim 12, wherein each of plurality of coupling paths is associated with an amplitude coupling value and a phase coupling value.

14: The method as claimed in claim 13, further comprising:
characterizing the plurality of coupling paths to determine the amplitude coupling values and phase coupling values associated with each coupling path.

15: The method as claimed in claim 14, wherein the step of characterizing comprises transmitting a third signal to each of the plurality of radio chains via the plurality of second ports.

16: The method as claimed in 12, wherein the step of calibrating comprises:
obtaining first estimates of first transfer functions associated with each of the plurality of radio chains receiving branches.

17: The method as claimed in claim 16, wherein the step of calibrating further comprises:
estimating, based on the first estimates and the coupling values, second estimates of second transfer functions associated with each of the plurality of radio chains transmitting branches;
estimating the first transfer functions based on the second estimates and the coupling values to update the first estimates; and
iteratively performing the estimating steps until the first estimates and the second estimates converge.

18: The method as claimed in claim 17, wherein the step of calibrating further comprises:
adjusting the amplitude settings and/or phase settings of the plurality of radio chains to compensate for differences in the first transfer functions and differences in the second transfer functions.

19: An apparatus for calibrating a plurality of radio chains, wherein the plurality of radio chains are connected to a plurality of first ports on a Radio Distribution Network Board (RDNB), wherein the RDNB comprises a plurality of coupling paths, wherein each coupling path is configured to provide non-directional coupling between two first ports, and a plurality of second ports for connecting to one or more external devices, wherein each first port is coupled to a respective second port, the apparatus comprising processing circuitry configured to cause the apparatus to:
transmit a first signal over each transmitting branch of the plurality of radio chains;
receive second signals at each receiving branch of the plurality of radio chains caused by the plurality of non-directional coupling paths; and
calibrate phase settings and/or amplitude settings of the plurality of radio chains based on the received second signals.

20: The apparatus as claimed in claim 19, wherein the processing circuitry is further configured to cause the apparatus to perform a method of calibrating a plurality of radio chains, wherein the plurality of radio chains are connected to a plurality of first ports on a Radio Distribution Network Board (RDNB), wherein the RDNB comprises: a plurality of coupling paths, wherein each coupling path is configured to provide coupling between two first ports, and each coupling path comprises one or more non-directional power splitter/combiners; and a plurality of second ports for connecting to one or more external devices, wherein each first port is coupled to a respective second port, the method comprising:
transmitting a first signal over each transmitting branch of the plurality of radio chains;
receiving second signals at each receiving branch of the plurality of radio chains caused by the plurality of coupling paths; and
calibrating phase settings and/or amplitude settings of the plurality of radio chains based on the received second signals.

21: The apparatus as claimed in claim 19, wherein the apparatus comprises an active antenna system.

22: A non-transitory computer readable medium comprising a computer program comprising instructions which, when executed on at least one processor, cause the at least one processor to carry out a method of calibrating a plurality of radio chains, wherein the plurality of radio chains are connected to a plurality of first ports on a Radio Distribution Network Board (RDNB), wherein the RDNB comprises: a plurality of coupling paths, wherein each coupling path is configured to provide coupling between two first ports, and each coupling path comprises one or more non-directional power splitter/combiners; and a plurality of second ports for connecting to one or more external devices, wherein each first port is coupled to a respective second port, the method comprising:
transmitting a first signal over each transmitting branch of the plurality of radio chains;
receiving second signals at each receiving branch of the plurality of radio chains caused by the plurality of coupling paths; and
calibrating phase settings and/or amplitude settings of the plurality of radio chains based on the received second signals.

23. (canceled)

24: A radio system comprising the apparatus of claim 19.

25: The radio system as claimed in claim 24, wherein the radio system comprises one of: a radio access node in a cellular communications network, an access point in a local wireless network and a wireless communication device.
